(19) United States
(12) Patent Application Publication
(10) Pub. No.: US 2025/0092230 A1
(43) Pub. Date: Mar. 20, 2025

(54) FDM CORE-SHELL FILAMENT COMPRISING WOOD AND OTHER PARTICLES

(71) Applicant: SIGNIFY HOLDING B.V., EINDHOVEN (NL)

(72) Inventors: TIES VAN BOMMEL, HORST (NL); RIFAT ATA MUSTAFA HIKMET, EINDHOVEN (NL)

(21) Appl. No.: 18/729,350

(22) PCT Filed: Jan. 23, 2023
(86) PCT No.: PCT/EP2023/051571

§ 371 Date: Jul. 16, 2024

(30) Foreign Application Priority Data
Jan. 28, 2022 (EP) 22153825.9

(51) Int. Cl. C08K 11/00; B22F 10/18; B28B 1/00; B29C 64/118; B29K 101/12; B29K 505/00; B29K 511/14; B33Y 70/10; C03B 19/01; C08K 3/10; F21V 7/04

(52) U.S. Cl. CPC C08K 11/00; B33Y 70/10; C08K 3/10; B22F 10/18; B28B 1/001; B29C 64/118; B29K 2101/12; B29K 2505/00; B29K 2511/14; B29K 2995/0025; C03B 19/01; F21V 7/04

(57) ABSTRACT

The invention provides a method for producing a 3D printed item (1) by means of fused deposition modelling, wherein the 3D printed item (1) comprises a plurality of layers (322) of 3D printed material (202), comprising a layer part (1322) with a 3D printed shell material (1302) at least partially surrounding a 3D printed core material (1202), wherein the method comprises layer-wise depositing a 3D printable material (201) comprising a 3D printable core material (1201) and a 3D printable shell material (1301), and wherein:—the 3D printable core material (1201) comprises one or more of metal particles (260) and a metal wire (270), and the 3D printable shell material (1301) comprises wood particles (250), or—the 3D printable core material (1201) comprises wood particles (250), and the 3D printable shell material (1301) comprises inorganic material particles (280) selected from the group of glass particles and ceramic particles.

### FIELD OF THE INVENTION

The invention relates to a method for manufacturing a 3D (printed) item. The invention also relates to the 3D (printed) item obtainable with such method. Further, the invention relates to a lighting device including such 3D (printed) item.

### BACKGROUND OF THE INVENTION

The use of wood for constructing wood 3D structures is known in the art. US2020/0369888, for instance, describes a composition comprising at least one wood material, at least one cellulose nano-material and at least one hemicellulose and/or lignin and/or starch, for use in (a) a process of fabrication of 3D wood objects; or (b) a process for coating or covering a surface region of an object with the wood material; wherein the composition is free of formaldehyde, synthetic resins and/or epoxy based materials. The composition may be in a form of a paste, or in a form of an ink composition. The 3D object is formed by casting, molding, extrusion, calendaring, injection, printing, hand-forming or manual processing.

### SUMMARY OF THE INVENTION

Within the next 10-20 years, digital fabrication will increasingly transform the nature of global manufacturing. One of the aspects of digital fabrication is 3D printing. Currently, many different techniques have been developed in order to produce various 3D printed objects using various materials such as ceramics, metals, and polymers. 3D printing can also be used in producing molds which can then be used for replicating objects.

For the purpose of making molds, the use of polyjet technique has been suggested. This technique makes use of layer by layer deposition of photo-polymerisable material which is cured after each deposition to form a solid structure. While this technique produces smooth surfaces the photo curable materials are not very stable, and they also have relatively low thermal conductivity to be useful for injection molding applications.

The most widely used additive manufacturing technology is the process known as Fused Deposition Modeling (FDM). Fused deposition modeling (FDM) is an additive manufacturing technology commonly used for modeling, prototyping, and production applications. FDM works on an “additive” principle by laying down material in layers; a plastic filament or metal wire is unwound from a coil and supplies material to produce a part. Possibly, (for thermoplastics for example) the filament is melted and extruded before being laid down. FDM is a rapid prototyping technology. Other terms for FDM are “fused filament fabrication” (FFF) or “filament 3D printing” (FDP), which are considered to be equivalent to FDM. In general, FDM printers use a thermoplastic filament, which is heated to its melting point and then extruded, layer by layer, (or in fact filament after filament) to create a three-dimensional object. FDM printers are relatively fast, low cost and can be used for printing complicated 3D objects. Such printers are used in printing various shapes using various polymers. The technique is also being further developed in the production of LED luminaires and lighting solutions.

Hence, it is an aspect of the invention to provide an alternative 3D printing method and/or 3D (printed) item which preferably further at least partly obviate(s) one or more of above-described drawbacks. The present invention may have as object to overcome or ameliorate at least one of the disadvantages of the prior art, or to provide a useful alternative.

In a first aspect, the invention provides a method for producing a 3D printed item by means of fused deposition modelling. In embodiments, the 3D printed item may comprise a plurality of layers of 3D printed material. Especially, the plurality of layers may comprise a layer part with a 3D printed shell material at least partially surrounding a 3D printed core material. Further, the method may especially comprise layer-wise depositing a 3D printable material comprising a 3D printable core material and a 3D printable shell material. In embodiments, the 3D printable core material may comprise one or more of metal particles and a metal wire; further, in specific embodiments the 3D printable shell material may comprise wood particles. Alternatively or additionally, the 3D printable core material may comprise wood particles; further, in specific embodiments the 3D printable shell material may comprise non-wood particles, such as inorganic material particles, especially selected from the group of glass particles and ceramic particles.

With such method, a 3D printed item (“item” or “3D item”) may be provided having the look and/or feel and/or texture of wood. In this way, people observing the object may not only visually perceive the object as wood, but may also feel, due to the texture and/or weight of the object, that the object is wood or wood-like. For instance, due to the weight increase of the 3D printed item with metal material, also safety may be improved as the 3D printed item may also behave like a wooden article. Further, the application of wood may also be useful, as waste material may be applied in a 3D printed item, which may reduce the use of new materials and/or may reduce the use of polymeric materials. Yet, the use of ceramic particles or glass particles may provide an easier cleanable surface and/or a more reliable or durable surface (the surface may be harder due to the optional presence of the ceramic particles or glass particles).

As indicated above the invention may provide a method for producing a 3D printed item by means of fused deposition modelling. The 3D printed item may comprise one or more layers of 3D printed material. Especially, the 3D printed item may comprise a plurality of layers of 3D printed material. One or more of these layers may comprise a layer part (“part”) with a 3D printed shell material at least partially surrounding a 3D printed core material. Hence, the 3D printed item may comprise a layer of which at least part comprises a core-shell structure. In cross-sectional view, the shell may enclose at least 30% of the perimeter of the core, like at least about 40%, such as in specific embodiments at least about 50%, like at least about 60%, more especially at least 75%, like in embodiment essentially 100%. Note that the core may not necessarily have a circular perimeter. This may be the case when a metal wire is applied (see below), but may not be the case when thermoplastic comprising core material is applied.

Especially, the method may comprise layer-wise depositing a 3D printable material comprising a 3D printable core material and a 3D printable shell material. Hence, a stack of layers may be provided. At least part of one of the layers, especially a part defined along a length axis of such layer, may have a core-shell configuration. Especially, a plurality of parts of one or more layers may have a core-shell configuration. Note that other parts may have different core-shell configuration or have different compositions, and/or may not be of the core-shell type.

Basically, there may be two series of embodiments, which may also be combined.

In a first series of embodiments, the 3D printable core material may comprise one or more of metal particles and a metal wire, and the 3D printable shell material may comprise wood particles. Hence, in such embodiments the core comprises a metal material, which may add to the specific gravity of the material, and the shell may comprise wood particles. Especially, at least a part of the total number of the wood particles in the shell may extend from the shell (to the external of the layer part). This may provide a wood tactile impression. Alternatively or additionally, the 3D printable shell material may be light transmissive, especially transparent, allowing at least part of the wood particles be visible in the 3D printed shell material. For instance, the 3D printable shell material (and thus the 3D printed shell material) may comprise a light transmissive thermoplastic material with wood particles at least partly embedded therein. The term “metal material” may refer to one or more of metal particles and metal wire.

In a second series of embodiments, the 3D printable core material may comprise wood particles, and the 3D printable shell material may comprise inorganic material particles, especially selected from the group of glass particles and ceramic particles. Hence, in such embodiments the core comprises a wood material, which may be visible through the 3D printed shell material (and/or the inorganic material particles), and the shell may comprise inorganic material particles. At least a part of the total number of the inorganic material particles in the shell may extend from the shell (to the external of the layer part). This may provide a wood tactile impression. Especially, the 3D printable shell material may be light transmissive, especially transparent, allowing at least part of the wood particles in the core be visible through the 3D printed shell material. For instance, the 3D printable shell material (and thus the 3D printed shell material) may comprise a light transmissive thermoplastic material with inorganic material particles at least partly embedded therein. Alternatively or additionally, the inorganic material particles may be light transmissive, like glass particles, which may allow at least part of the wood particles in the core be visible through the 3D printed shell material and/or the inorganic material particles.

The term “inorganic material” may especially refer to oxide materials, such as oxides, aluminates, borates, phosphates, silicates, etc., though other materials are not excluded, like (oxy) halides, etc. The term “inorganic material”, however, may especially not refer to pure metal materials. Such metal materials are herein (thus) indicated as “metal materials”.

Hence, in specific embodiments the invention provides a method for producing a 3D printed item by means of fused deposition modelling, wherein the 3D printed item comprises a plurality of layers of 3D printed material, comprising a layer part with a 3D printed shell material at least partially surrounding a 3D printed core material, wherein the method comprises layer-wise depositing a 3D printable material comprising a 3D printable core material and a 3D printable shell material, and wherein: (a) the 3D printable core material comprises one or more of metal particles and a metal wire, and the 3D printable shell material comprises wood particles, or (b) the 3D printable core material comprises wood particles, and the 3D printable shell material comprises inorganic material particles selected from the group of glass particles and ceramic particles.

In embodiments, the 3D printable material may comprise the 3D printable core material and the 3D printable shell material. These materials may be provided as separate materials, like pellets, and may be introduced into a core-shell nozzle, in the respective core part and shell part. In this way, a core-shell extrudate may be produced, leading to a deposited 3D printed material having a core-shell configuration. Alternatively, these materials may be provided as core-shell filament, and may be introduced into a nozzle. In this way, a core-shell extrudate may be produced, leading to a deposited 3D printed material having a core-shell configuration.

Herein, the term “core material” may refer to 3D printable core material or 3D printed core material”. Note that they may essentially have the same composition; the former however may refer to material to be printed and the latter may refer to material that has been printed. Herein, the term “shell material” may refer to 3D printable shell material or 3D printed shell material”. Note that they may essentially have the same composition; the former however may refer to material to be printed and the latter may refer to material that has been printed. Hence, in the context of 3D printable material, 3D printable core material is not necessarily (at least partly) enclosed by 3D printable shell material, when e.g. pellets of 3D printable material are applied, which are provided to a core-shell nozzle. In the context of 3D printable material, 3D printable core material may (at least partly) be enclosed by 3D printable shell material when e.g. a filament of 3D printable material is applied. However, in the context of 3D printed material, 3D printed core material may (at least partly) be enclosed by 3D printed shell material.

As indicated above, there may be two series of embodiments, of which one may be based on the combination of wood particles and metal material, and the other on wood particles and (light transmissive) inorganic material particles. Embodiments of the former series are described first, and then of the second series.

In embodiments, the 3D printable core material may comprise one or more of a metal wire, and a thermoplastic material with embedded metal particles.

When using a metal wire, especially a printer nozzle with a single opening can be applied, through which thermoplastic material (especially for the 3D printable shell material) and metal wire may be guided, to 3D print the 3D printed material comprising a core-shell configuration, with the core comprising the metal wire. The core material may be defined by the metal wire. The 3D printable material may especially be 3D printable due to the presence of thermoplastic material in the shell and optionally in the core. The metal wire may thus be 3D printed as it is embedded in 3D printable thermoplastic material. In other embodiments, however, the 3D printable core material may comprise a metal wire and thermoplastic material. In such embodiments, a core-shell filament may be used or a core-shell nozzle. The metal wire may have a largest cross-sectional dimension of at maximum 0.5*the layer height of the 3D printed layer. Alternatively or additionally, the metal wire may have a largest cross-sectional dimension of at maximum 1 mm, such as especially at maximum 500 μm, like in embodiments 50-250 μm.

Alternatively, or optionally additionally, in embodiments the 3D printable core material may comprise a combination of one or more of a metal wire, and a thermoplastic material with embedded metal particles. In embodiments, the metal particles may have sizes selected from the range of 0.1-3000 μm, such as selected from the range of 5-1000 μm, such as especially selected from the range of 5-200 μm. A volume concentration of the metal particles in the 3D printed core material (and thus also in the 3D printable core material) may be selected from the range of 5-50 vol. %, such as at least about 10 vol. %, like in the range of 10-40 vol. %.

The metal wire may be an elongated wire. However, the metal wire may also be provided as pieces of wire, i.e. pieces having lengths of more than 3 mm, such as at least 5 mm. The width and/or height may be as indicated above in relation to the sizes of the metal particles.

In further embodiments, the method may comprise first selecting the 3D printable core material and the 3D printable shell material, and second, choosing 3D printing conditions such that the 3D printed material 3D printed during the at least part of the 3D printing stage has a specific weight of at least at least 4 g/cm³, 5 g/cm³. Hence, the relative volumes of core material and shell material may be controlled such that the 3D printed material (or at least the layer part) is provided with a core-shell configuration and having a specific weight of at least 4 g/cm³, more especially at least at least 5 g/cm³, such as selected from the range of 5-15 g/cm³.

In further embodiments, the method may comprise selecting the 3D printable shell material and choosing 3D printing conditions such that the 3D printed shell material is not transparent for visible light. In this way, a metal look may be prevented. Transparency of the 3D printed shell material may be prevented by selecting one or more of a layer thickness of the 3D printed shell material, a volume concentration of the wood particles, a dye concentration, and a pigment concentration. A dye or a pigment may be dispersed in the thermoplastic material of the 3D printed shell material. The dye or pigment may e.g. be a brown(ish) dye or a brown(ish) pigment. A volume concentration of the wood particles in the 3D printed shell material (and thus also in the 3D printable shell material) may be selected from the range of 5-50 vol. %, such as at least about 10 vol. %, like in the range of 10-40 vol. %.

As indicated above, another series of embodiments may be based on the combination of wood particles and (light transmissive) inorganic material particles, wherein the former are (at least) comprised by the 3D printed core material and the latter are (at least) comprised by the 3D printed shell material.

In yet further embodiments, the 3D printed item may comprise 3D printable core material comprising wood particles, and the 3D printable shell material may comprise inorganic material particles.

A volume concentration of the wood particles in the 3D printed core material (and thus also in the 3D printable core material) may be selected from the range of 5-50 vol. %, such as at least about 10 vol. %, like in the range of 10-40 vol. %.

As indicated above, the 3D printable shell material may be light transmissive, especially transparent, allowing at least part of the wood particles be visible in the 3D printed shell material. To this end, the thermoplastic material may be light transmissive and/or the inorganic material particles may be light transmissive. Especially, both may be light transmissive. For instance, the inorganic material particles may comprise glass particles. In other embodiments, the inorganic material particles may comprise ceramic particles.

Instead of or in addition to inorganic material particles, polymeric material particles may be applied. Hence, in specific embodiments, other non-wood particles may be applied, especially light transmissive non-wood particles, may be applied in the 3D printable shell material (and thus 3D printed shell material). Hence, the non-wood particles and/or the inorganic material particles may comprise light transmissive material.

The light transmissive material may comprise one or more materials selected from the group consisting of a transmissive organic material, such as selected from the group consisting of PE (polyethylene), PP (polypropylene), PEN (polyethylene naphthalate), PC (polycarbonate), polyurethanes (PU), polymethylacrylate (PMA), polymethylmethacrylate (PMMA) (Plexiglas or Perspex), polymethacrylimide (PMI), polymethylmethacrylimide (PMMI), styrene acrylonitrile resin (SAN), cellulose acetate butyrate (CAB), silicone, polyvinylchloride (PVC), polyethylene terephthalate (PET), including in an embodiment (PETG) (glycol modified polyethylene terephthalate), PDMS (polydimethylsiloxane), and COC (cyclo olefin copolymer). Especially, the light transmissive material may comprise an aromatic polyester, or a copolymer thereof, such as e.g. one or more of polycarbonate (PC), poly (methyl)methacrylate (P(M)MA), polyglycolide or polyglycolic acid (PGA), polylactic acid (PLA), polycaprolactone (PCL), polyethylene adipate (PEA), polyhydroxy alkanoate (PHA), polyhydroxy butyrate (PHB), poly(3-hydroxybutyrate-co-3-hydroxyvalerate) (PHBV), polyethylene terephthalate (PET), polybutylene terephthalate (PBT), polytrimethylene terephthalate (PTT), polyethylene naphthalate (PEN). Especially, the light transmissive material may comprise polyethylene terephthalate (PET). Hence, the light transmissive material is especially a polymeric light transmissive material.

However, in another embodiment the light transmissive material may comprise an inorganic material. Especially, the inorganic light transmissive material may be selected from the group consisting of glasses, (fused) quartz, transmissive ceramic materials, and silicones. Also hybrid materials, comprising both inorganic and organic parts may be applied. Especially, the light transmissive material comprises one or more of PMMA, transparent PC, or glass.

For instance, the light transmissive material may comprise a ceramic body, like a garnet type of material. In alterative embodiments, the light transmissive material may comprise an alumina material, such as an Al₂O₃ based material. In embodiments, the light transmissive material may comprise e.g. sapphire. Other materials may also be possible like one or more of CaF₂, MgO, BaF₂, A₃B₅O₁₂ garnet, ALON (aluminum oxynitride), MgAl₂O₄ and MgF₂.

The term “transmissive” may e.g. refer to transparent or translucent. Herein, especially transparent materials may be desirable when materials are indicated as transmissive.

Especially, the method may comprise selecting the 3D printable shell material and choosing 3D printing conditions such that the 3D printed shell material is transmissive for visible light. For instance, light transmissivity of the 3D printed shell material may especially be facilitated by selecting one or more of a layer thickness of the 3D printed shell material, a volume concentration of the non-wood particles and/or the inorganic material particles, and the type of the non-wood particles and/or the inorganic material particles. Especially, no dye or pigment may be added, or only in very low volume concentrations, like e.g. <1 vol. % (relative to the volume of the 3D printed shell material (or 3D printable shell material).

A volume concentration of the inorganic material particles in the 3D printed shell material (and thus also in the 3D printable shell material) may be selected from the range of 5-50 vol. %, such as at least about 10 vol. %, like in the range of 10-40 vol. %, such as at least about 20 vol. %. Likewise, this may apply to other non-wood particles in the 3D printed shell material. Would different types of non-wood particles be applied, including inorganic material particles, the total particle volume concentration in the 3D printed shell material (and thus also in the 3D printable shell material) may be selected from the range of 5-50 vol. %, such as at least about 10 vol. %, like in the range of 10-40 vol. %, such as at least about 20 vol. %.

In specific embodiments, the 3D printable shell material may comprise inorganic metal particles that may protrude from the 3D printed shell material. This may be facilitated by selecting at least one particle dimension in the range of the layer thickness of the 3D printed shell material. For instance, a particle dimension may be in the range of 80-120% of a thickness of the 3D printed shell material. Further, it may be useful to select a relatively high inorganic material particles volume concentration. Hence, in embodiments the 3D printable shell material may comprise at least 20 vol. % of inorganic material particles, more especially at least vol. % of inorganic material particles. In embodiments, a particle dimension may be in the range of 80-100% of a thickness of the 3D printed shell material. Yet, in other embodiments a particle dimension may be in the range of larger than 100%, such as up to 120% of a thickness of the 3D printed shell material.

In embodiments, a particle dimension of particles may refer to a dimension of at least 20 vol. % of all such particles, like at least 40 vol. %, yet even more especially at least 50 vol. %, like in embodiments at least 60 vol. %.

In yet further embodiments, the 3D printable core material may comprise a volume percentage of wood particles V_{c,W}, and the 3D printable shell material may comprise a volume percentage of wood particles V_{s,W}. Further, the 3D printable core material; may comprise a volume percentage of metal material V_{c,M} and the 3D printable shell material may comprise a volume percentage of metal material V_{s,M}. Yet further, the 3D printable core material may comprise a volume percentage of inorganic material particles V_{c,I} and the 3D printable shell material may comprise a volume percentage of inorganic material particles V_{s,I}.

In embodiments, V_{s,M}/V_{c,M}≤0.2, more especially V_{s,M}/V_{e,M}≤0.1. In this way, the volume percentage of the metal material in the 3D printable shell material may be much less than the volume percentage of the metal material in the 3D printable core material. In specific embodiments, V_{c,M} may be essentially zero. In such embodiments, wherein essentially no metal material is available in the 3D printable core material (or 3D printed core material), there may also be essentially no metal material in the 3D printable shell material (or 3D printed shell material). Especially, V_{s,M}/V_{c,M}≤0.01.

In embodiments, V_{c,I}/V_{s,I}≤0.2, more especially V_{c,I}/V_{s,I}≤0.1. In this way, the volume percentage of the inorganic material particles in the 3D printable core material may be much less than the volume percentage of the inorganic material particles in the 3D printable shell material. In specific embodiments, V_{s,I} may be essentially zero. In such embodiments, wherein essentially no inorganic particle material may be available in the 3D printable shell material (or 3D printed shell material), there may also be essentially no inorganic particle material in the 3D printable core material (or 3D printed core material). Especially V_{c,I}/V_{s,I}≤0.01.

In embodiments, the volume percentage of metal material V_{c,M} comprised by the 3D printable core material may be selected from a range including and extending from 0 vol. % to 100 vol./%. When the metal material is provided by particles, V_{c,M} may be selected from a range including and extending from 0 vol. % to 50 vol. % (see further also above). In the case that the 3D printable core material is provided by a metal wire, the volume percentage may be larger, as the entire core may be provided by the metal wire (see also above).

In further embodiments, the volume percentage of the inorganic material particles V_{s,I} in the 3D printable shell material may be selected from a range including and extending from 0 vol. % to 50 vol. % (see also above).

In embodiments, wherein wood particles are especially available in the shell, the volume percentage thereof may larger than of optional wood particles in the core. Hence, in embodiments V_{s,W}>V_{c,W}, more especially V_{c,W}/V_{s,W}≤0.1, like V_{c,W}/V_{s,W}≤0.01. In specific embodiments, V_{c,W}=0%. In embodiments, wherein wood particles are available in the shell, then the volume percentage of the metal material in the core may especially be larger than zero and especially the volume percentage of the inorganic material in the shell is equal to or smaller than the volume percentage of the metal in the shell. The latter may be zero volume percent. Alternatively or additionally, in embodiments V_{s,I}/V_{s,W}≤0.1. However, other embodiments may also be possible. Therefore, in specific embodiments, when V_{s,W}>V_{c,W} then (i) 0 vol. %<V_{c,M}≤100 vol. % and (ii) and V_{s,I}≤V_{s,M}. Especially, 5 vol. %≤V_{c,M}≤100 vol. %.

In embodiments, wherein wood particles are especially available in the core, the volume percentage thereof may larger than of optional wood particles in the shell. Hence, in (other) embodiments V_{c,W}>V_{s,W}, more especially V_{s,W}/V_{c,W}≤0.1, like V_{s,W}/V_{c,W}≤0.01. In specific embodiments, V_{s,W}=0%. In embodiments, wherein wood particles are available in the core, then the volume percentage of the inorganic particle material in the shell may especially be larger than zero and especially the volume percentage of the inorganic material in the core is equal to or smaller than the volume percentage of the metal material in the core. The latter may be zero volume percent. Alternatively or additionally, in embodiments V_{c,M}/V_{c,I}≤0.1. However, other embodiments may also be possible. Therefore, in specific embodiments, when V_{c,W}>V_{s,W} then (i) 0 vol. %<V_{s,I}<50 vol. % and (ii) and V_{c,M}≤V_{c,I}. Especially, 5 vol. %≤V_{s,I}≤50 vol. %.

Therefore, it is not excluded that when using a core comprising wood particles, and the shell comprising inorganic materials particles, the shell may comprise wood particles and/or metal particles. Especially, however the volume percentages thereof in the shell may be smaller than volume percentage of the wood particles in the core.

In other words, when the 3D printable core material comprises wood particles, and the 3D printable shell material comprises inorganic material particles selected from the group of glass particles and ceramic particles, the 3D printable core material comprises wood particles at a core volume percentage, and the 3D printable shell material may comprise wood particles at a shell volume percentage, wherein a ratio of the shell volume percentage and the core volume percentage is smaller than one, such as equal to or smaller than 0.5, or equal to or smaller than 0.1, or even zero.

It is, however, also not excluded that when using a shell comprising wood particles, and the core comprising metal material, the core may comprise inorganic material particles and wood particles. Especially, however, the volume percentages thereof in the core may be smaller than the volume percentage of the wood particles in the shell.

In other words, when the 3D printable core material comprises one or more of metal particles and a metal wire, and the 3D printable shell material comprises wood particles, the 3D printable shell material comprises wood particles at a shell volume percentage, and the 3D printable core material may comprise wood particles at a core volume percentage, wherein a ratio of the core volume percentage and the shell volume percentage is smaller than one, such as equal to or smaller than 0.5, or equal to or smaller than 0.1, or even zero.

The wood particles may in embodiments be selected from residual wood material, shattered wood material, compressed wood material, etc.

In embodiments, the wood particles may comprise wood selected from the group of alder, aformosia, apple, ash (white or European), beech, birch, blue gum, box, cedar of Lebanon, cherry, chestnut, dogwood, ebony, elm, greenheart, gum, hackberry, hickory, holly, iroko, juniper, keruing, larch, lignum vitae, lime, locust, logwood, madrone, magnolia, mahogany, maple, meranti, myrtle, oak, pine, pear, pecan, persimmon, plane, plum, ramin, rosewood, sapele, satinwood, tanguile, teak, utile, walnut, water gum, yew, and zebrawood. Especially, the wood may be selected from the group of blue gum, box, ebony, greenheart, lignum vitae, logwood, persimmon, rosewood (especially east Indian), statin wood, teak (especially African), and water gum.

In embodiments, the 3D printable material and the 3D printed material may comprise of one or more of polycarbonate (PC), polyethylene (PE), high-density polyethylene (HDPE), polypropylene (PP), polyoxymethylene (POM), polyethylene naphthalate (PEN), styrene-acrylonitrile resin (SAN), polysulfone (PSU), polyphenylene sulfide (PPS), and semi-crystalline polytethylene terephthalate (PET), acrylonitrile butadiene styrene (ABS), poly(methyl methacrylate) (PMMA), polystyrene (PS), and styrene acrylic copolymers (SMMA). However, other thermoplastic materials may also be applied.

In embodiments, the 3D printable core material and the 3D printable shell material may comprise the same thermoplastic material. This may facilitate adhesion between the core material and shell material.

In further embodiments, the 3D printable core material may comprise metal particles and one or more of a wood-color pigment and a wood-color dye. This may add to the wood perception and may block perception of and/or reflection by metal material comprised by the core material.

In further embodiments, the 3D printable shell material may comprise wood particles have particle lengths (L1), and particle heights (L2) and/or particle widths (L3), with aspect ratios (i) L1/L2 of at least 5 and (ii) L1/L3 of at least 5. In specific embodiments, L1/L2 may be at least 10. In specific embodiments, L1/L2 may be selected from the range of up to 1000. In specific embodiments, L1/L3 may be at least 10. In specific embodiments, L1/L3 may be selected from the range of up to 1000. Such dimensions may e.g. facilitate sticking out from the shell and/or may allow better visibility of the particles.

In embodiments, the 3D printable shell material may comprise one or more of glass or ceramic beads. Especially such materials may provide a relatively good transmission of visible light. Visible light may have one or more wavelength in the wavelength range of 380-370 nm.

In embodiments, the 3D printable shell material may comprise a combination of (a) one or more of ceramic particles and glass particles having a first refractive index n1, and (b) a thermoplastic material having a second refractive index n2, wherein n1 and n2 comply with |n1−n2|≤0.2, more especially |n1−n2|≤0.1, like e.g. |n1−n2|≤0.05. In this way, the refractive indices may be essentially the same. This may facilitate transmission of visible light through the 3D printed shell material.

In further embodiments, the inorganic material particles may have particle lengths (L1), and particle heights (L2) and/or particle widths (L3), with aspect ratios (i) L1/L2 of at least 5 and (ii) L1/L3 of at least 5. In specific embodiments, L1/L2 may be at least 10. In specific embodiments, L1/L2 may be selected from the range of up to 1000. In specific embodiments, L1/L3 may be at least 10. In specific embodiments, L1/L3 may be selected from the range of up to 1000. Such dimensions may e.g. facilitate sticking out from the shell and/or may allow better visibility of the particles and/or through the 3D printed shell material.

In further embodiments, the 3D printed core material may have a height (H1) and the 3D printed shell material may have a width W2, such that the height of the 3D printed core material is larger than the width of the 3D printed shell material according to H1>W2. This may facilitate stacking of layers. Especially, in embodiments 0.3≤W2/H1≤0.95.

In embodiments, the metal material may comprise one or more of copper, iron, zinc, nickel, and tin. These metal materials may thus be provided as metals.

As can be derived from the above, in an aspect the invention may (also) provide a method for producing a 3D printed item by means of FDM, which comprises a 3D printing stage comprising layer-wise deposition of an extrudate comprising 3D printable material, that may provide the 3D printed item comprising of 3D printed material on a receiver item. Especially, the 3D printed item may comprise a plurality of layers of 3D printed material during at least part of the printing stage. Further, the 3D printable material comprises a 3D printable core material and 3D printable shell material. Especially, the 3D printable core material may comprise one or more of metal particles and a metal wire, and the 3D printable shell material may comprise wood particles. Further, the 3D printable core material may comprise wood particles, and the 3D printable shell material may comprise inorganic material particles selected from the group of glass particles and ceramic particles. Further, the thus obtained 3D printed item may comprise a layer, which comprises a layer part, which further comprises 3D printed core material and 3D printed shell material. Especially, the 3D printed shell material at least partially surrounds the 3D printed core material. Further, the 3D printed core material may comprise one or more of metal particles and a metal wire, and the 3D printed shell material may comprise wood particles. Especially, the 3D printed core material may comprise wood particles, and the 3D printed shell material may comprise inorganic material properties selected from the group of glass particles and ceramic particles.

As indicated above, the method may comprise depositing during a printing stage 3D printable material. Herein, the term “3D printable material” refers to the material to be deposited or printed, and the term “3D printed material” refers to the material that is obtained after deposition. These materials may be essentially the same, as the 3D printable material may especially refer to the material in a printer head or extruder at elevated temperature and the 3D printed material refers to the same material, but in a later stage when deposited. In embodiments, the 3D printable material may be printed as a filament and deposited as such. The 3D printable material may be provided as filament or may be formed into a filament. Hence, whatever starting materials are applied, a filament comprising 3D printable material may be provided by the printer head and 3D printed. The term “extrudate” may be used to define the 3D printable material downstream of the printer head, but not yet deposited. The latter may be indicated as “3D printed material”. In fact, the extrudate may be considered to comprises 3D printable material, as the material is not yet deposited. Upon deposition of the 3D printable material or extrudate, the material may thus be indicated as 3D printed material. Essentially, the materials may be the same material, as the thermoplastic material upstream of the printer head, downstream of the printer head, and when deposited, may essentially be the same material(s).

Herein, the term “3D printable material” may also be indicated as “printable material”. The term “polymeric material” may in embodiments refer to a blend of different polymers, but may in embodiments also refer to essentially a single polymer type with different polymer chain lengths. Hence, the terms “polymeric material” or “polymer” may refer to a single type of polymers but may also refer to a plurality of different polymers. The term “printable material” may refer to a single type of printable material but may also refer to a plurality of different printable materials. The term “printed material” may refer to a single type of printed material but may also refer to a plurality of different printed materials.

Hence, the term “3D printable material” may also refer to a combination of two or more materials. In general, these (polymeric) materials have a glass transition temperature T_{g} and/or a melting temperature Tₘ. The 3D printable material will be heated by the 3D printer before it leaves the nozzle to a temperature of at least the glass transition temperature, and in general at least the melting temperature. Hence, in a specific embodiment the 3D printable material comprises a thermoplastic polymer having a glass transition temperature (T_{g}) and/or a melting point I, and the printer head action may comprises heating the 3D printable material above the glass transition and in embodiments above the melting temperature (especially when the thermoplastic polymer is a semi-crystalline polymer). In yet another embodiment, the 3D printable material comprises a (thermoplastic) polymer having a melting poI(Tₘ), and the 3D printing stage may comprise heating the 3D printable material to be deposited on the receiver item to a temperature of at least the melting point. The glass transition temperature is in general not the same thing as the melting temperature. Melting is a transition which may occur in crystalline polymers. Melting may happen when the polymer chains fall out of their crystal structures, and become a disordered liquid. The glass transition may be a transition which happens to amorphous polymers; that is, polymers whose chains are not arranged in ordered crystals, but are just strewn around in any fashion, even though they are in the solid state. Polymers can be amorphous, essentially having a glass transition temperature and not a melting temperature or can be (semi) crystalline, in general having both a glass transition temperature and a melting temperature, with in general the latter being larger than the former. The glass temperature may e.g. be determined with differential scanning calorimetry. The melting point or melting temperature can also be determined with differential scanning calorimetry.

As indicated above, the invention may thus provide a method comprising providing a filament of 3D printable material and printing during a printing stage said 3D printable material on a substrate, to provide said 3D item.

Materials that may especially qualify as 3D printable materials may be selected from the group consisting of metals, glasses, thermoplastic polymers, silicones, etc. Especially, the 3D printable material comprises a (thermoplastic) polymer selected from the group consisting of ABS (acrylonitrile butadiene styrene), Nylon (or polyamide), Acetate (or cellulose), PLA (poly lactic acid), terephthalate (such as PET polyethylene terephthalate), Acrylic (polymethylacrylate, Perspex, polymethylmethacrylate, PMMA), Polypropylene (or polypropene), Polycarbonate (PC), Polystyrene (PS), PE (such as expanded—high impact—Polythene (or polyethene), Low density (LDPE) High density (HDPE)), PVC (polyvinyl chloride) Polychloroethene, such as thermoplastic elastomer based on copolyester elastomers, polyurethane elastomers, polyamide elastomers polyolefine based elastomers, styrene based elastomers, etc. Optionally, the 3D printable material may comprise a 3D printable material selected from the group consisting of Urea formaldehyde, Polyester resin, Epoxy resin, Melamine formaldehyde, thermoplastic elastol, etc. . . . Optionally, the 3D printable material may comprise a 3D printable material selected from the group consisting of a polysulfone. Elastomers, especially thermoplastic elastomers, may especially be interesting as they are flexible and may help obtaining relatively more flexible filaments comprising the thermally conductive material. A thermoplastic elastomer may comprise one or more of styrenic block copolymers (TPS (TPE-s)), thermoplastic polyolefin elastomers (TPO (TPE-o)), thermoplastic vulcanizates (TPV (TPE-v or TPV)), thermoplastic polyurethanes (TPU (TPU)), thermoplastic copolyesters (TPC (TPE-E)), and thermoplastic polyamides (TPA (TPE-A)).

Suitable thermoplastic materials, such as also mentioned in WO2017/040893, may include one or more of polyacetals (e.g., polyoxyethylene and polyoxymethylene), poly(C₁₋₆ alkyl)acrylates, polyacrylamides, polyamides, (e.g., aliphatic polyamides, polyphthalamides, and polyaramides), polyamideimides, polyanhydrides, polyarylates, polyarylene ethers (e.g., polyphenylene ethers), polyarylene sulfides (e.g., polyphenylene sulfides), polyarylsulfones (e.g., polyphenylene sulfones), polybenzothiazoles, polybenzoxazoles, polycarbonates (including polycarbonate copolymers such as polycarbonate-siloxanes, polycarbonate-esters, and polycarbonate-ester-siloxanes), polyesters (e.g., polycarbonates, polyethylene terephthalates, polyethylene naphtholates, polybutylene terephthalates, polyarylates), and polyester copolymers such as polyester-ethers), polyetheretherketones, polyetherimides (including copolymers such as polyetherimide-siloxane copolymers), polyetherketoneketones, polyetherketones, polyethersulfones, polyimides (including copolymers such as polyimide-siloxane copolymers), poly(C₁₋₆ alkyl)methacrylates, polymethacrylamides, polynorbornenes (including copolymers containing norbornenyl units), polyolefins (e.g., polyethylenes, polypropylenes, polytetrafluoroethylenes, and their copolymers, for example ethylene-alpha-olefin copolymers), polyoxadiazoles, polyoxymethylenes, polyphthalides, polysilazanes, polysiloxanes, polystyrenes (including copolymers such as acrylonitrile-butadiene-styrene (ABS) and methyl methacrylate-butadiene-styrene (MBS)), polysulfides, polysulfonamides, polysulfonates, polysulfones, polythioesters, polytriazines, polyureas, polyurethanes, polyvinyl alcohols, polyvinyl esters, polyvinyl ethers, polyvinyl halides, polyvinyl ketones, polyvinyl thioethers, polyvinylidene fluorides, or the like, or a combination comprising at least one of the foregoing thermoplastic polymers. Embodiments of polyamides may include, but are not limited to, synthetic linear polyamides, e.g., Nylon-6,6; Nylon-6,9; Nylon-6,10; Nylon-6, 12; Nylon-11; Nylon-12 and Nylon-4,6, preferably Nylon 6 and Nylon 6,6, or a combination comprising at least one of the foregoing. Polyurethanes that can be used include aliphatic, cycloaliphatic, aromatic, and polycyclic polyurethanes, including those described above. Also useful are poly(C₁₋₆ alkyl)acrylates and poly(C₁₋₆ alkyl)methacrylates, which include, for instance, polymers of methyl acrylate, ethyl acrylate, acrylamide, methacrylic acid, methyl methacrylate, n-butyl acrylate, and ethyl acrylate, etc. In embodiments, a polyolefine may include one or more of polyethylene, polypropylene, polybutylene, polymethylpentene (and co-polymers thereof), polynorbornene (and co-polymers thereof), poly 1-butene, poly(3-methylbutene), poly(4-methylpentene) and copolymers of ethylene with propylene, 1-butene, 1-hexene, 1-octene, 1-decene, 4-methyl-1-pentene and 1-octadecene.

In specific embodiments, the 3D printable material (and the 3D printed material) may comprise one or more of polycarbonate (PC), polyethylene (PE), high-density polyethylene (HDPE), polypropylene (PP), polyoxymethylene (POM), polyethylene naphthalate (PEN), styrene-acrylonitrile resin (SAN), polysulfone (PSU), polyphenylene sulfide (PPS), and semi-crystalline polytethylene terephthalate (PET), acrylonitrile butadiene styrene (ABS), poly(methyl methacrylate) (PMMA), polystyrene (PS), and styrene acrylic copolymers (SMMA).

The term 3D printable material is further also elucidated below, but may especially refer to a thermoplastic material, optionally including additives, to a volume percentage of at maximum about 60%, especially at maximum about 30 vol. %, such as at maximum 20 vol. % (of the additives relative to the total volume of the thermoplastic material and additives).

The printable material may thus in embodiments comprise two phases. The printable material may comprise a phase of printable polymeric material, especially thermoplastic material (see also below), which phase is especially an essentially continuous phase. In this continuous phase of thermoplastic material polymer additives such as one or more of antioxidant, heat stabilizer, light stabilizer, ultraviolet light stabilizer, ultraviolet light absorbing additive, near infrared light absorbing additive, infrared light absorbing additive, plasticizer, lubricant, release agent, antistatic agent, anti-fog agent, antimicrobial agent, colorant, laser marking additive, surface effect additive, radiation stabilizer, flame retardant, anti-drip agent may be present. The additive may have useful properties selected from optical properties, mechanical properties, electrical properties, thermal properties, and mechanical properties (see also above).

The printable material in embodiments may comprise particulate material, i.e. particles embedded in the printable polymeric material, which particles form a substantially discontinuous phase. The number of particles in the total mixture may especially not be larger than 60 vol. %, relative to the total volume of the printable material (including the (anisotropically conductive) particles) especially in applications for reducing thermal expansion coefficient. For optical and surface related effect number of particles in the total mixture is equal to or less than 20 vol. %, such as up to 10 vol. %, relative to the total volume of the printable material (including the particles). Hence, the 3D printable material may especially refer to a continuous phase of essentially thermoplastic material, wherein other materials, such as particles, may be embedded. Likewise, the 3D printed material especially refers to a continuous phase of essentially thermoplastic material, wherein other materials, such as particles, are embedded. The particles may comprise one or more additives as defined above. Hence, in embodiments the 3D printable materials may comprises particulate additives.

The printable material may be printed on a receiver item. Especially, the receiver item can be the building platform or can be comprised by the building platform. The receiver item can also be heated during 3D printing. However, the receiver item may also be cooled during 3D printing.

The phrase “printing on a receiver item” and similar phrases include amongst others directly printing on the receiver item, or printing on a coating on the receiver item, or printing on 3D printed material earlier printed on the receiver item. The term “receiver item” may refer to a printing platform, a print bed, a substrate, a support, a build plate, or a building plIorm, etc. Instead of the term “receiver item” also the term “substrate” may be used. The phrase “printing on a receiver item” and similar phrases include amongst others also printing on a separate substrate on or comprised by a printing platform, a print bed, a support, a build plate, or a buildinglatform, etc. Therefore, the phrase “printing on a substrate” and similar phrases include amongst others directly printing on the substrate, or printing on a coating on the substrate or printing on 3D printed material earlier printed on the substrate. Here below, further the term substrate is used, which may refer to a printing platform, a print bed, a substrate, a support, a build plate, or a building platform, etc., or a separate substrate thereon or comprised thereby.

Layer by layer printable material may be deposited, by which the 3D printed item may be generated (during the printing stage). The 3D printed item may show a characteristic ribbed structures (originating from the deposited filaments). However, it may also be possible that after a printing stage, a further stage is executed, such as a finalization stage. This stage may include removing the printed item from the receiver item and/or one or more post processing actions. One or more post processing actions may be executed before removing the printed item from the receiver item and/or one more post processing actions may be executed after removing the printed item from the receiver item. Post processing may include e.g. one or more of polishing, coating, adding a functionIcomponent, etc. Post-processing may include smoothening the ribbed structures, which may lead to an essentially smooth surface.

Further, the invention relates to a software product that can be used to execute the method described herein. Therefore, in yet a further aspect the invention also provides a computer program product, when running on a computer which is functionally coupled to or comprised by a fused deposition modeling 3D printer, is capable of bringing about the method as described herein.

Hence, in an aspect the invention (thus) provides a software product, which, when running on a computer is capable of bringing about (one or more embodiments of) the method (for producing a 3D item by means of fused deposition modelling) as described herein.

The herein described method provides 3D printed items. Hence, the invention also provides in a further aspect a 3D printed item obtainable with the herein described method. In a further aspect a 3D printed item obtainable with the herein described method is provided. Especially, the invention provides a 3D printed item (“3D item” or “item”) comprising a plurality of layers of 3D printed material. Especially, the plurality of layers may comprise a layer part, further comprises 3D printed core material and 3D printed shell material, where the 3D printed shell material at least partially surrounds the 3D printed core material. Further, the 3D printed core material may comprise one or more of metal particles and the metal wire, and the 3D printed shell material comprises wood particles. Further, the 3D printed core material may comprise wood particles, and the 3D printed shell material may comprise inorganic material particles selected from the group of glass particles and ceramic particles. Hence, in embodiments the invention provides a 3D printed item comprising 3D printed material, wherein the 3D printed item comprises a plurality of layers of 3D printed material, wherein a layer part comprises (a) 3D printed core material and (b) 3D printed shell material at least partially surrounding the 3D printed core material; wherein the 3D printed core material comprises one or more of metal particles and the metal wire, and the 3D printed shell material comprises wood particles, or the 3D printed core material comprises wood particles, and the 3D printed shell material comprises inorganic material particles selected from the group of glass particles and ceramic particles. Especially, the layer part may be provided according the herein described method for producing a 3D printed item.

Especially, the 3D printed item may comprise one or more layers of 3D printed material. More especially, the 3D printed item comprises a plurality of layers of 3D printed material. The 3D printed item may comprise two or more, like at least 5, such as at least 10, like in embodiments at least 20 layers of 3D printed material.

The 3D printed item may comprise a plurality of layers on top of each other, i.e. stacked layers. The width (thickness) and height of (individually 3D printed) layers may e.g. in embodiments be selected from the range of 100-5000 μm, such as 200-2500 μm, with the height in general being smaller than the width. For instance, the ratio of height and width may be equal to or smaller than 0.8, such as equal to or smaller than 0.6.

Layers may be core-shell layers or may consist of a single material. Within a layer, there may also be a change in composition, for instance when a core-shell printing process was applied and during the printing process it was changed from printing a first material (and not printing a second material) to printing a second material (and not printing the first material).

At least part of the 3D printed item may include a coating.

Some specific embodiments in relation to the 3D printed item have already been elucidated above when discussing the method. Below, some specific embodiments in relation to the 3D printed item are discussed in more detail.

As indicated above, in embodiments, wherein the 3D printed core material may further comprise one or more of (i) a metal wire, and (ii) a thermoplastic material with metal particles embedded therein, the layer part may have a specific weight of at least 5 g/cm³. The specific weight may in embodiments be up to about 1.5 g/cm³, such as up to about 1.1 g/cm³.

In further embodiments, the 3D printed item described above may comprises 3D printed shell material that is not transparent for visible light. Especially, this may be useful for optically perceiving the wood particles in the core material through the shell material.

In embodiments, wherein the 3D printed core material may comprise wood particles, and wherein the 3D printed shell material may comprise inorganic material particles, especially the 3D printed shell material may be transmissive for visible light. As may be indicated above, this may be useful for optically perceiving the wood particles in the core material through the shell material.

Especially, as also indicated above, at least part of the inorganic material particles may protrude from the 3D printed shell material. Further, in embodiments the 3D printed shell material may comprise at least 10 vol. % of the inorganic material particles.

In further embodiments, the 3D printed core material (of the 3D printed item), may comprise a volume percentage V_{c,W} of wood particles, and the 3D printed shell material may comprise a volume percentage V_{s,W} wood particles. Further, the 3D printed core material may comprise a volume percentage V_{c,M} metal material (260,270), and the 3D printed shell material may comprise a volume percentage V_{s,M} metal material (260,270). Especially, the 3D printed core material may comprise a volume percentage V_{c,I} inorganic material particles, and the 3D printed shell material may comprise a volume percentage V_{s,I} inorganic material particles.

In embodiments, the metal particles or wire, if available, should especially be in the core. Especially, V_{s,M}/V_{c,M}≤0.1 may apply. Further, the glass or ceramic particles, if available, should especially be in the shell. Hence, especially V_{c,I}/V_{s,I}≤0.1 may apply. In embodiments, 0 vol. %≤V_{c,M}≤100 vol. % and/or 0 vol. %≤V_{s,I}≤50 vol. %.

In embodiments, the configuration may essentially be metal core and wood material shell. Then, inorganic material in the shell may be lower than the metal material in the shell, or both may be zero. In specific embodiments, when V_{s,W}>V_{c,W} then (i) 0 vol. %<V_{c,M}≤100 vol. % and (ii) and V_{s,I}≤V_{s,M}.

In embodiments, the configuration may essentially be wood material in the core and glass/ceramic material in the shell. Then, the metal material in the core may be lower than the glass/ceramic material in the core, or both may be zero. In specific embodiments, when V_{c,W}>V_{s,W} then (i) 0 vol. %<V_{s,I}≤50 vol. % and (ii) and V_{c,M}≤V_{c,I}.

The (with the herein described method) obtained 3D printed item may be functional per se. For instance, the 3D printed item may be a lens, a collimatI a reflector, etc. . . . The thus obtained 3D item may (alternatively) be used for decorative or artistic purposes. The 3D printed item may include or be provided with a functional component. The functional component may especially be selected from the group consisting of an optical component, an electrical component, and a magnetic component. The term “optical component” especially refers to a component having an optical functionality, such as a lens, a mirror, a light transmissive element, I optical filter, etc. . . . The term optical component may also refer to a light source (like a LED). The term “electrical component” may e.g. refer to an integrated circuit, PCB, a battery, a driver, but also a light source (as a light source may be considered an optical component and an electrical component), etc. The term magnetic component may e.g. refer to a magneI connector, a coil, etc. . . . Alternatively, or additionally, the functional component may comprise a thermal component (e.g. configured to cool or to heat an electrical component). Hence, the functional component may be configured to generate It or to scavenge heat, etc. . . .

As indicated above, the 3D printed item maybe used for different purposes. Amongst others, the 3D printed item maybe used in lighting. Hence, in yet a further aspect the invention also provides a lighting device comprising the 3D item as defined herein. In a specific aspect the invention provides a lighting system comprising (a) a light source configured to provide (visible) light source light and (b) the 3D item as defined herein, wherein 3D item may be configured as one or more of (i) at least part of a housing, (ii) at least part of a wall of a lighting chamber, and (iii) a functional component, wherein the functional component may be selected from the group consisting of an optical component, a support, an electrically insulating component, an electrically conductive component, a thermally insulating component, and a thermally conductive component. Hence, in specific embodiments the 3D item may be configured as one or more of (i) at least part of a lighting device housing, (ii) at least part of a wall of a lighting chamber, and (iii) an optical element. As a relative smooth surface may be provided, the 3D printed item male used as mirror or lens, etc. . . . In embodiments, the 3D item may be configured as shade. A device or system may comprise a plurality of different 3D printed items, having different functionalities.

Returning to the 3D printing process, a specific 3D printer may be used to provide the 3D printed item described herein. Therefore, in yet a further aspect the invention also provides a fused deposition modeling 3D printer, comprising (a) a printer head comprising a printer nozzle, and (b) a 3D printable material providing device configured to provide 3D printable material to the printer head, wherein the fused deposition modeling 3D printer is configured to provide said 3D printable material as defined above and/or the 3D printed item as defined above.

The printer nozzle may include a single opening. In other embodiments, the printer nozzle may be of the core-shell type, having two (or more) openings. The term “printer head” may also refer to a plurality of (different) printer heads; hence, the term “printer nozzle” may also refer to a plurality of (different) printer nozzles.

The 3D printable material providing device may provide a filament comprising 3D printable material to the printer head or may provide the 3D printable material as such, with the printer head creating the filament comprising 3D printable material. Hence, in embodiments the invention provides a fused deposition modeling 3D printer, comprising (a) a printer head comprising a printer nozzle, and (b) a filament providing device configured to provide a filament comprising 3D printable material to the printer head, wherein the fused deposition modeling 3D printer is configured to provide said 3D printable material to a substrate, as defined above and/or the 3D printed item as defined above.

Especially, the 3D printer may comprise a controller (or is functionally coupled to a controller) that is configured to execute in a controlling mode (or “operation mode”) the method as described herein. Instead of the term “controller” also the term “control system” (see e.g. above) may be applied.

The term “controlling” and similar terms especially refer at least to determining the behavior or supervising the running of an element. Hence, herein “controlling” and similar terms may e.g. refer to imposing behavior to the element (determining the behavior or supervising the running of an element), etc., such as e.g. measuring, displaying, actuating, opening, shifting, changing temperature, etc. Beyond that, the term “controlling” and similar terms may additionally include monitoring. Hence, the term “controlling” and similar terms may include imposing behavior on an element and also imposing behavior on an element and monitoring the element. The controlling of the element can be done with a control system, which may also be indicated as “controller”. The control system and the element may thus at least temporarily, or permanently, functionally be coupled. The element may comprise the control system. In embodiments, the control system and element may not be physically coupled. Control can be done via wired and/or wireless control. The term “control system” may also refer to a plurality of different control systems, which especially are functionally coupled, and of which e.g. one control system may be a master control system and one or more others may be slave control systems. A control system may comprise or may be functionally coupled to a user interface.

The control system may also be configured to receive and execute instructions form a remote control. In embodiments, the control system may be controlled via an App on a device, such as a portable device, like a Smartphone or I-phone, a tablet, etc. The device is thus not necessarily coupled to the lighting system, but may be (temporarily) functionally coupled to the lighting system.

Hence, in embodiments the control system may (also) be configured to be controlled by an App on a remote device. In such embodiments the control system of the lighting system may be a slave control system or control in a slave mode. For instance, the lighting system may be identifiable with a code, especially a unique code for the respective lighting system. The control system of the lighting system may be configured to be controlled by an external control system which has access to the lighting system on the basis of knowledge (input by a user interface of with an optical sensor (e.g. QR code reader) of the (unique) code. The lighting system may also comprise means for communicating with other systems or devices, such as on the basis of Bluetooth, WIFI, LiFi, ZigBee, BLE or WiMAX, or another wireless technology.

The system, or apparatus, or device may execute an action in a “mode” or “operation mode” or “mode of operation”. Likewise, in a method an action or stage, or step may be executed in a “mode” or “operation mode” or “mode of operation” or “operational mode”. The term “mode” may also be indicated as “controlling mode”. This does not exclude that the system, or apparatus, or device may also be adapted for providing another controlling mode, or a plurality of other controlling modes. Likewise, this may not exclude that before executing the mode and/or after executing the mode one or more other modes may be executed.

However, in embodiments a control system may be available, that is adapted to provide at least the controlling mode. Would other modes be available, the choice of such modes may especially be executed via a user interface, though other options, like executing a mode in dependence of a sensor signal or a (time) scheme, may also be possible. The operation mode may in embodiments also refer to a system, or apparatus, or device, that can only operate in a single operation mode (i.e. “on”, without further tunability).

Hence, in embodiments, the control system may control in dependence of one or more of an input signal of a user interface, a sensor signal (of a sensor), and a timer. The term “timer” may refer to a clock and/or a predetermined time scheme.

Instead of the term “fused deposition modeling (FDM) 3D printer” shortly the terms “3D printer”, “FDM printer” or “printer” may be used. The printer nozzle may also be indicated as “nozzle” or sometimes as “extruder nozzle”.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIGS. 1a-1c schematically depict some general aspects of the 3D printer and of an embodiment of 3D printed material;

FIGS. 2a-2e schematically depicts some further aspects of the method of the invention;

FIG. 3a-3f schematically depict some aspects of embodiments of particles, with some of the shapes being depicted for reference purposes;

FIG. 4 schematically depicts an application.

The schematic drawings are not necessarily to scale.

### DETAILED DESCRIPTION OF THE EMBODIMENTS

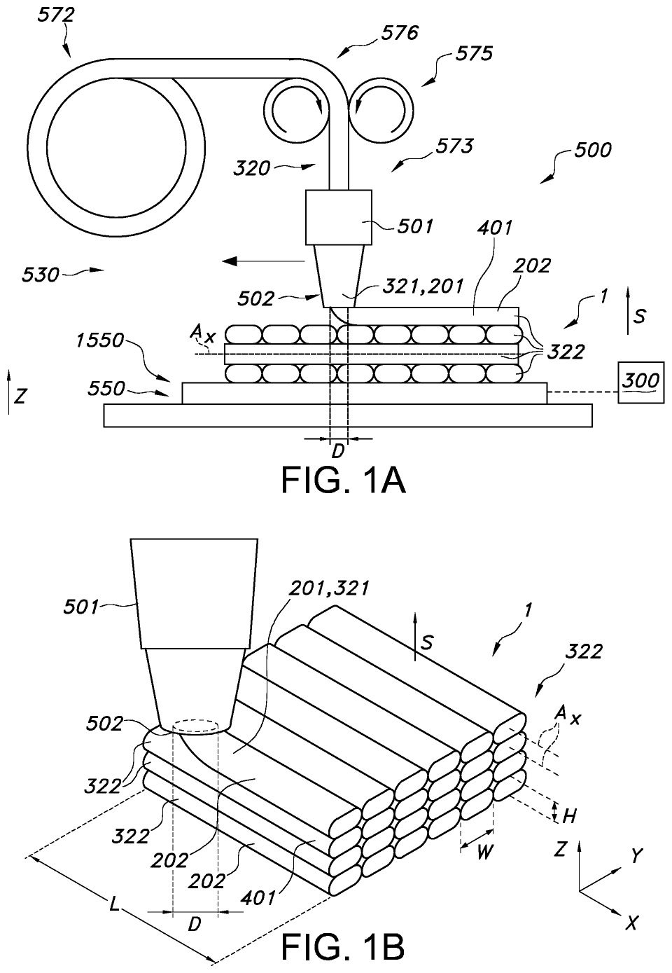

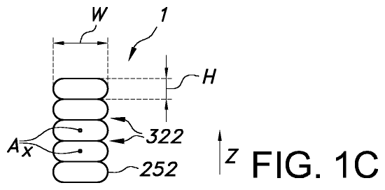

FIG. 1a schematically depicts some aspects of the 3D printer. Reference 500 indicates a 3D printer. Reference 530 indicates the functional unit configured to 3D print, especially FDM 3D printing; this reference may also indicate the 3D printing stage unit. Here, only the printer head for providing 3D printed material, such as an FDM 3D printer head is schematically depicted. Reference 501 indicates the printer head. The 3D printer of the present invention may especially include a plurality of printer heads (see below). Reference 502 indicates a printer nozzle. The 3D printer of the present invention may especially include a plurality of printer nozzles, though other embodiments are also possible. Reference 320 indicates a filament of printable 3D printable material (such as indicated above).

Instead of a filament also pellets may be used as 3D printable material. Both can be extruded via the printer nozzle.

For the sake of clarity, not all features of the 3D printer have been depicted, only those that are of especial relevance for the present invention (see further also below). Reference 321 indicates extrudate (of 3D printable material 201).

The 3D printer 500 is configured to generate a 3D item 1 by layer-wise depositing on a receiver item 550, which may in embodiments at least temporarily be cooled, a plurality of layers 322 wherein each layers 322 comprises 3D printable material 201, such as having a melting point Tₘ. The 3D printable material 201 may be deposited on a substrate 1550 (during the printing stage). By deposition, the 3D printable material 201 has become 3D printed material 202. 3D printable material 201 escaping from the nozzle 502 is also indicated as extrudate 321. Reference 401 indicates thermoplastic material.

The 3D printer 500 may be configured to heat the filament 320 material upstream of the printer nozzle 502. This may e.g. be done with a device comprising one or more of an extrusion and/or heating function. Such device is indicated with reference 573, and is arranged upstream from the printer nozzle 502 (i.e. in time before the filament material leaves the printer nozzle 502). The printer head 501 may (thus) include a liquefier or heater. Reference 201 indicates printable material. When deposited, this material is indicated as (3D) printed material, which is indicated with reference 202.

Reference 572 indicates a spool or roller with material, especially in the form of a wire, which may be indicated as filament 320. The 3D printer 500 transforms this in an extrudate 321 downstream of the printer nozzle which becomes a layer 322 on the receiver item or on already deposited printed material. In general, the diameter of the extrudate 321 downstream of the nozzle 502 is reduced relative to the diameter of the filament 322 upstream of the printer head 501. Hence, the printer nozzle is sometimes (also) indicated as extruder nozzle. Arranging layer 322 by layer 322, a 3D item 1 may be formed. Reference 575 indicates the filament providing device, which here amongst others include the spool or roller and the driver wheels, indicated with reference 576.

Reference Ax indicates a longitudinal axis or filament axis.

Reference 300 schematically depicts a control system. The control system may be configured to control the 3D printer 500. The control system 300 may be comprised or functionally coupled to the 3D printer 500. The control system 300 may further comprise or be functionally coupled to a temperature control system configured to control the temperature of the receiver item 550 and/or of the printer head 501. Such temperature control system may include a heater which is able to heat the receiver item 550 to at least a temperature of 50° C., but especially up to a range of about 350° C., such as at least 200° C.

Alternatively or additionally, in embodiments the receiver plate may also be moveable in one or two directions in the x-y plane (horizontal plane). Further, alternatively or additionally, in embodiments the receiver plate may also be rotatable about z axis (vertical). Hence, the control system may move the receiver plate in one or more of the x-direction, y-direction, and z-direction.

Alternatively, the printer can have a head can also rotate during printing. Such a printer has an advantage that the printed material cannot rotate during printing.

Layers are indicated with reference 322, and have a layer height H and a layer width W.

Note that the 3D printable material is not necessarily provided as filament 320 to the printer head. Further, the filament 320 may also be produced in the 3D printer 500 from pieces of 3D printable material.

Reference D indicates the diameter of the nozzle (through which the 3D printable material 201 is forced). However, the nozzle not necessarily has a circular cross-section.

FIG. 1b schematically depicts in 3D in more detail the printing of the 3D item 1 under construction. Here, in this schematic drawing the ends of the filaments 321 in a single plane are not interconnected, though in reality this may in embodiments be the case. Reference H indicates the height of a layer. Layers are indicated with reference 203. Here, the layers have an essentially circular cross-section. Often, however, they may be flattened, such as having an outer shape resembling a flat oval tube or flat oval duct (i.e. a circular shaped bar having a diameter that is compressed to have a smaller height than width, wherein the sides (defining the width) are (still) rounded).

Hence, FIGS. 1a-1b schematically depict some aspects of a fused deposition modeling 3D printer 500, comprising (a) a first printer head 501 comprising a printer nozzle 502, (b) a filament providing device 575 configured to provide a filament 321 comprising 3D printable material 201 to the first printer head 501, and optionally (c) a receiver item 550. In FIGS. 1a-1b, the first or second printable material or the first or second printed material are indicated with the general indications printable material 201 and printed material 202, respectively. Directly downstream of the nozzle 502, the filament 321 with 3D printable material becomes, when deposited, layer 322 with 3D printed material 202.

FIG. 1c schematically depicts a stack of 3D printed layers 322, each having a layer height H and a layer width W. Note that in embodiments the layer width and/or layer height may differ for two or more layers 322. Reference 252 in FIG. 1c indicates the item surface of the 3D item (schematically depicted in FIG. 1c).

Referring to FIGS. 1a-1c, the filament of 3D printable material that is deposited leads to a layer having a height H (and width W). Depositing layer 322 after layer 322, the 3D item 1 is generated. FIG. 1c very schematically depicts a single-walled 3D item 1.

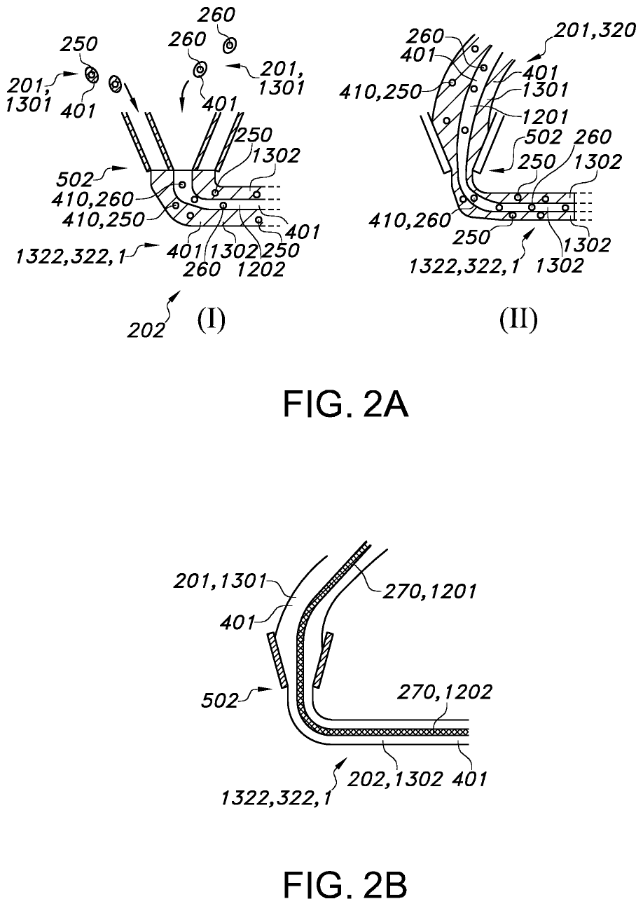

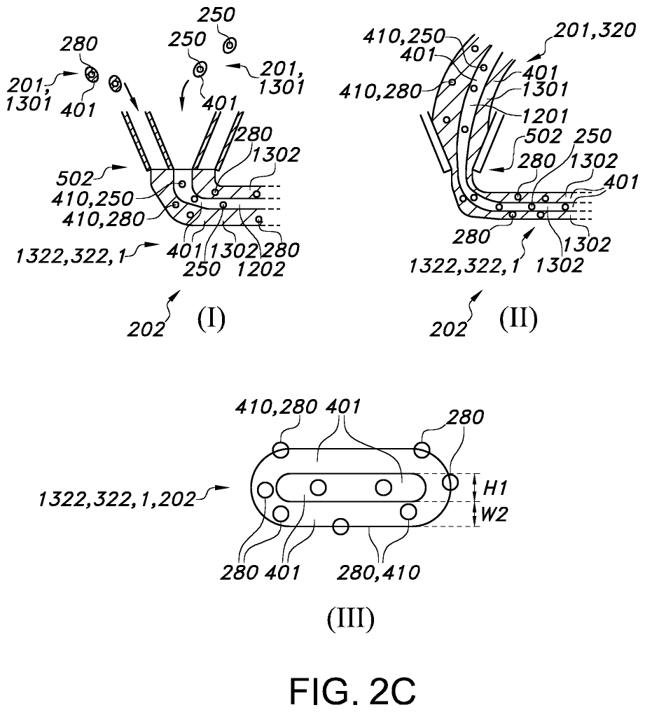

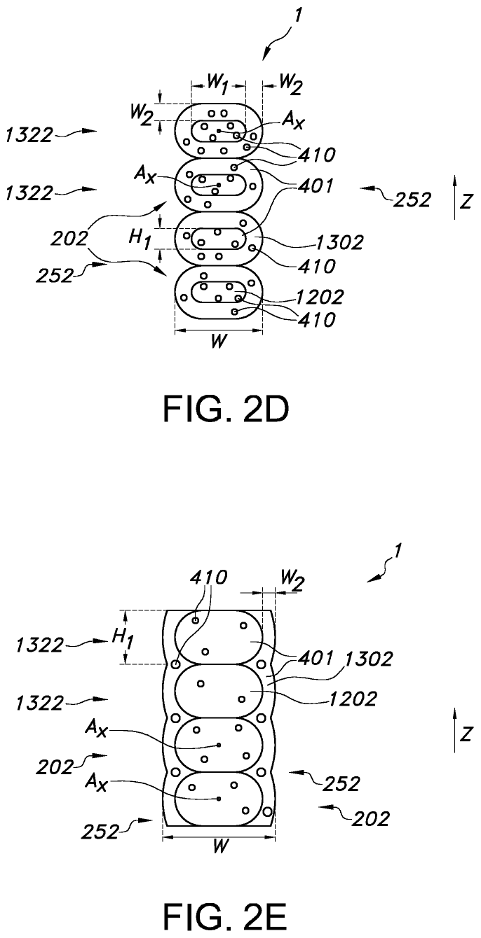

FIG. 2a-2c schematically depict some embodiments and aspects in relation to the method for producing the 3D printed item 1 as well as the 3D printed item 1.

Amongst others, the invention provides a method for producing a 3D printed item 1 by means of fused deposition modelling. The 3D printed item 1 may comprise a plurality of layers 322 of 3D printed material 202 (see e.g. also FIGS. 1a-1c), comprising a layer part 1322 with a 3D printed shell material 1302 at least partially surrounding a 3D printed core material 1202. The method may comprise layer-wise depositing a 3D printable material 201 comprising a 3D printable core material 1201 and a 3D printable shell material 1301.

Particles in general are indicated with reference 410. Specific type of particle 410 are indicated with different references, like wood particles 250 or metal particles 260 or inorganic material particles 280.

The 3D printable core material 1201 may comprise one or more of metal particles 260 (see FIG. 2a) and a metal wire 270 (see FIG. 2b), and the 3D printable shell material 1301 may comprise wood particles 250. In other embodiments, the 3D printable core material 1201 comprises wood particles 250, and the 3D printable shell material 1301 comprises inorganic material particles 280 selected from the group of glass particles and ceramic particles; see also FIG. 2c. As schematically depicted in FIG. 2c, at least part of the total number of particles 410 may extend from the shell (to the external of the layer part).

FIG. 2a shows in embodiment I a core-shell nozzle 502 and in embodiment II a nozzle where a filament 320 is provided to. Hence, the 3D printable material may comprise the 3D printable core material 1201 and the 3D printable shell material 1301. These materials may be provided as separate materials, like pellets, and may be introduced into a core-shell nozzle, in the respective core part and shell part see embodiment I. In this way, a core-shell extrudate may be produced, leading to a deposited 3D printed material having a core-shell configuration. Alternatively, see embodiment II, these materials may be provided as core-shell filament, and may be introduced into a nozzle. In this way, a core-shell extrudate may be produced, leading to a deposited 3D printed material having a core-shell configuration.

The (thus obtained) 3D printed item 1 may comprise a layer 322 comprising (a) layer part 1322, wherein the layer part 1322 comprises a 3D printed core material 1202 and (b) 3D printed shell material 1302 at least partially surrounding the 3D printed core material 1202.

In embodiments, (i) the 3D printed core material 1202 may comprise one or more of metal particles 260 and the metal wire 270, and the 3D printed shell material 1302 comprises wood particles 250, or (ii) the 3D printed core material 1202 may comprise wood particles 250, and the 3D printed shell material 1302 comprises inorganic material particles 280 selected from the group of glass particles and ceramic particles.

The 3D printable core material 1201 may comprise one or more of (i) a metal wire 270, and (ii) a thermoplastic material 401 with metal particles 260 embedded therein.

The method may comprise selecting the 3D printable core material 1201 and the 3D printable shell material 1301 and choosing 3D printing conditions such that the 3D printed material 202 3D printed during the at least part of the 3D printing stage has a specific weight of at least 5 g/cm³. The method may comprise selecting the 3D printable shell material 1301 and choosing 3D printing conditions such that the 3D printed shell material 1302 is not transparent for visible light.

In embodiments, wherein the 3D printable core material 1201 comprises wood particles 250, wherein the 3D printable shell material 1301 comprises inorganic material particles 280. Further, the method may comprise selecting the 3D printable shell material 1301 and choosing 3D printing conditions such that the 3D printed shell material 1302 may be transmissive for visible light.

In embodiments, at least part of the inorganic material particles 280 protrudes from the 3D printed shell material 1302; this is schematically depicted in embodiment III of FIG. 2c. Here, the protrusion of part of the particles is schematically depicted in relation to inorganic material particles 280. However, this may also apply for wood particles 250 when available I the shell (and metal material in the core).

In embodiments, the 3D printable shell material 1301 may comprise at least 20 vol. % of the inorganic material particles 280, and at least part of the inorganic material particles 280 have a dimension selected from 80-120% of a thickness of the 3D printed shell material 1302.

The 3D printable core material 1201 comprises a volume percentage V_{c,W} wood particles 250 and the 3D printable shell material 1301 comprises a volume percentage V_{s,W} wood particles 250. Further, the 3D printable core material 1201 may comprise a volume percentage V_{c,M} metal material 260,270 and the 3D printable shell material 1301 comprises a volume percentage V_{s,M} metal material 260,270. Yet, the 3D printable core material 1201 comprises a volume percentage V_{c,I} inorganic material particles 280. Further, the 3D printable shell material 1301 comprises a volume percentage V_{s,I} inorganic material particles 280.

In embodiments, one or more of the following may apply: (a) V_{s,M}/V_{c,M}≤0.1, (b) V_{c,I}/V_{s,I}≤0.1, (c) 0 vol. %≤V_{c,M}≤100 vol. %, and (d) 0 vol. %≤V_{s,I}≤50 vol. %.

Especially, in embodiments when V_{s,W}>V_{c,W} then (i) 0 vol. %<V_{c,M}≤100 vol. % and (ii) and V_{s,I}≤V_{s,M}. In other embodiments, when V_{c,W}>V_{s,W} then (i) 0 vol. %<V_{s,I}≤50 vol. % and (ii) and V_{c,M}≤V_{c,I}.

The 3D printed item 1 may comprise 3D printed material 202, wherein the 3D printed item 1 comprises a plurality of layers 322 of 3D printed material 202, wherein a layer part 1322 comprises a 3D printed core material 1202 and b 3D printed shell material 1302 at least partially surrounding the 3D printed core material 1202. Especially, (a) the 3D printed core material 1202 may comprise one or more of metal particles 260 and metal wire 270, and the 3D printed shell material 1302 comprises wood particles 250, or (b) the 3D printed core material 1202 may comprise wood particles 250, and the 3D printed shell material 1302 may comprise inorganic material particles 280 selected from the group of glass particles and ceramic particles. Combinations, however, may also be possible in specific embodiments.

FIGS. 2d-2e schematically depict a stack of 3D printed core-shell layers. The layers comprise core-shell layer of 3D printed material 202 and comprising a core and a shell. The core comprises a core material comprising a core composition. The shell comprises a shell material comprising a shell composition different from the core composition, e.g. in physical, chemical, and/or optical properties. Further, the core height of the core is indicated with reference H1, and the width of the core is indicated with reference W1. The shell has a shell width W2. The shell width W2 may herein also be referred to as thickness W2 of the shell. FIG. 2d depicts an embodiment wherein (in each core-shell layer) the shell substantially complete encloses the core. In FIG. 2e, the shell partly encloses the core in each of the core-shell layers.

Further, as shown in FIGS. 2d-2e, the width W1 of the core and the width W2 of the shell may be determined essentially perpendicular to the stacking height. Further, the height of the core H1 may be determined essentially parallel to the stacking height.

FIG. 2e further exemplifies an embodiment comprising a plurality of core-shell layers on top of each other wherein the shell widths W2 between two adjacent cores is 0 μm, and wherein the shell width W2 at at least one of the sides of the cores is non-zero. In the embodiments, the shell width W2 at both sides of the cores is non-zero. Further, two surfaces 252 of the item 1 are schematically indicated.

FIGS. 2d-2e very schematically depict a 3D item 1 with an item wall (comprising two surfaces). FIG. 2e further depicts that both surfaces of the wall comprise the shell material and no core material. In further embodiments, one of the surfaces or sections of surfaces of the wall comprise the shell material. In the former embodiment (with one surface comprising the shell material) especially the shell material may be arranged only at one side of the core material 331. In FIG. 2e, the shell material is arranged at two sides of core material 331.

FIGS. 2d-2e further illustrate the difference between embodiments wherein in the core-shell layer, the shell material completely encloses the core material (FIG. 2d) and embodiments wherein in the 3D item 1, the shell material (almost) completely encloses the core material (FIG. 2e). As indicated above, in cross-sectional view, the shell may enclose at least 30% of the perimeter of the core (see FIGS. 2d,2e), like at least about 40%, such as at least 75%, like in embodiment essentially 100% (see FIG. 2d).

Referring to FIGS. 2d-2e, the term “shell width” may especially refer to the largest shell width. The term “core height” may also especially refer to the largest core height. The term “core width” may also especially refer to the largest core width. Especially, the largest shell width is the width of the shell in the same plane as the largest core width.

The stack of layers may be a layer part 1322. The layer part 1322 may be smaller or larger. Further, the layer part 1322 may be part of a larger 3D printed item (not shown in FIGS. 2d-2d), wherein other parts may have been 3D printed according to different methods, like not core-shell, and/or other materials.

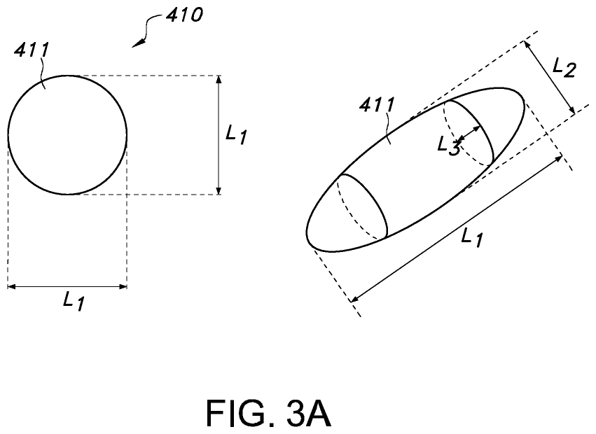

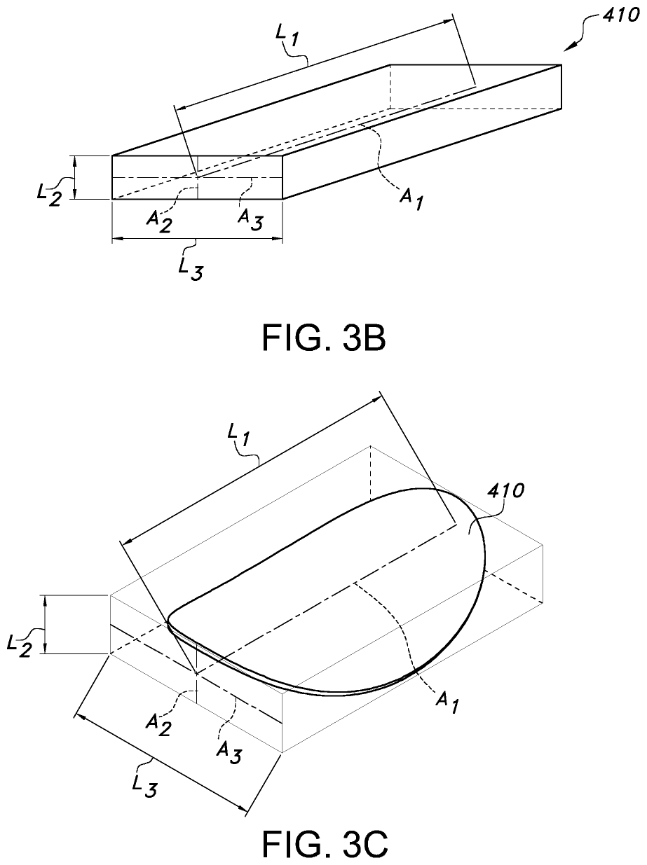

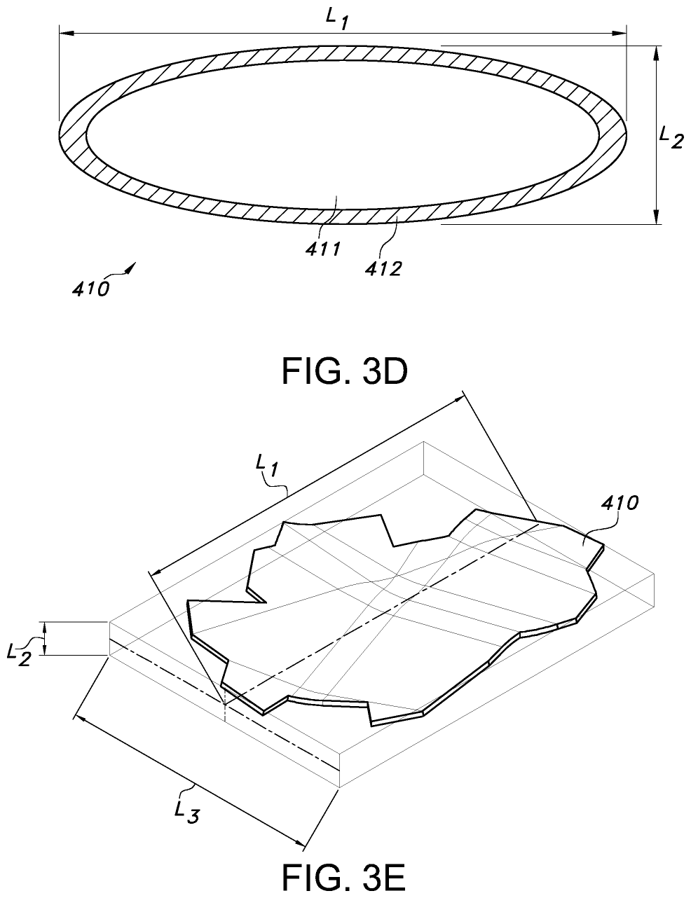

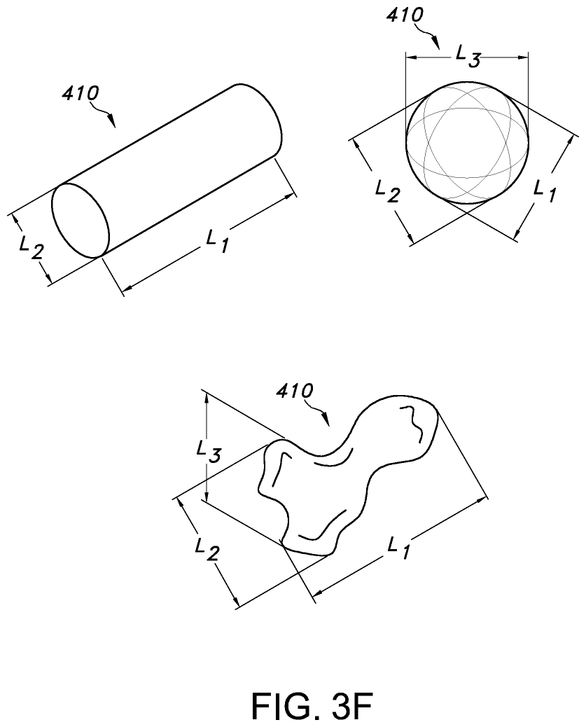

FIG. 3a-3f schematically depict for the sake of understanding particles 410 and some aspects thereof. Note that the particles used in the present invention are especially relative flat, see e.g. FIGS. 3d and 3e. The particles are indicated with reference 410.

The particles comprise a material 411, or may essentially consist of such material 411. The particles 410 have a first dimension or length L1. In the left example, L1 is essentially the diameter of the essentially spherical particle. On the right side a particle is depicted which has non spherical shape, such as an elongated particle 410. Here, by way of example L1 is the particle length. L2 and L3 can be seen as width and height. Of course, the particles may comprise a combination of differently shaped particles.

As indicated above, the particles 410 may e.g. comprise as material 411 wood, inorganic material, or metal.

FIGS. 3b-3f schematically depict some aspects of the particles 410. Some particles 410 have a longest dimension Al having a longest dimension length L1 and a shortest dimension A2 having a shortest dimension length L2. As can be seen from the drawings, the longest dimension length L1 and the shortest dimension length L2 have a first aspect ratio larger than 1. FIG. 3b schematically depicts a particle 410 in 3D, with the particle 410 having a length, height and width, with the particle (or flake) essentially having an elongated shape. Hence, the particle may have a further (minor or main) axis, herein indicated as further dimension A3. Essentially, the particles 410 are thin particles, i.e. L2<L1, especially L2<<L1, and L2<<L3. L1 may e.g. be selected from the range of 5-200 μm; likewise L3 may be. L2 may e.g. be selected from the range of 0.1-20 μm.

FIG. 3c schematically depicts a particle that has a less regular shape such as pieces of broken glass, with a virtual smallest rectangular parallelepiped enclosing the particle.

Note that the notations L1, L2, and L3, and A1, A2 and A3 are only used to indicate the axes and their lengths, and that the numbers are only used to distinguish the axis. Further, note that the particles are not essentially oval or rectangular parallelepiped. The particles may have any shape with at least a longest dimension substantially longer than a shortest dimension or minor axes, and which may essentially be flat. Especially, particles are used that are relatively regularly formed, i.e. the remaining volume of the fictive smallest rectangular parallelepiped enclosing the particle is small, such as less than 50%, like less than 25%, of the total volume.

FIG. 3d schematically depicts in cross-sectional view a particle 410 including a coating 412. The coating may comprise light reflective material. For instance, the coating may comprise a (white) metal oxide. In other embodiments, the coating may essentially consist of a metal, such as an Ag coating. In other embodiments the coatings may only be on one or both of the large surfaces and not on the thin side surfaces of the particles.

FIG. 3e schematically depicts a relatively irregularly shaped particle. The particulate material that is used may comprise e.g. small broken glass pieces. Hence, the particulate material that is embedded in the 3D printable material or is embedded in the 3D printed material may include a broad distribution of particles sizes. A rectangular parallelepiped can be used to define the (orthogonal) dimensions with lengths L1, L2 and L3.

FIG. 3f schematically depicts cylindrical, spherical, and irregularly shaped particles, which will herein in general not be used (see also above).

As shown in FIGS. 3b-3f the terms “first dimension” or “longest dimension” especially refer to the length L1 of the smallest rectangular cuboid (rectangular parallelepiped) enclosing the irregular shaped particle. When the particle is essentially spherical the longest dimension L1, the shortest dimension L2, and the diameter are essentially the same.

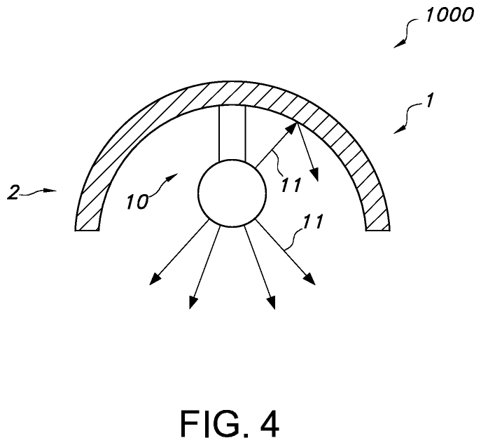

FIG. 4 schematically depicts an embodiment of a lamp or luminaire, indicated with reference 2, which comprises a light source 10 for generating light 11. The lamp may comprise a housing or shade or another element, which may comprise or be the 3D printed item 1. Here, the half sphere (in cross-sectional view) schematically indicates a housing or shade. The lamp or luminaire may be or may comprise a lighting device 1000 (which comprises the light source 10). Hence, in specific embodiments the lighting device 1000 comprises the 3D item 1. The 3D item 1 may be configured as one or more of (i) at least part of a lighting device housing, (ii) at least part of a wall of a lighting chamber, and (iii) an optical element. Hence, the 3D item may in embodiments be reflective for light source light 11 and/or transmissive for light source light 11. Here, the 3D item may e.g. be a housing or shade. The housing or shade comprises the item part 400. For possible embodiments of the item part 400, see also above.

The term “plurality” refers to two or more.

The terms “substantially” or “essentially” herein, and similar terms, will be understood by the person skilled in the art. The terms “substantially” or “essentially” may also include embodiments with “entirely”, “completely”, “all”, etc. Hence, in embodiments the adjective substantially or essentially may also be removed. Where applicable, the term “substantially” or the term “essentially” may also relate to 90% or higher, such as 95% or higher, especially 99% or higher, even more especially 99.5% or higher, including 100%.

The term “comprise” also includes embodiments wherein the term “comprises” means “consists of”.

The term “and/or” especially relates to one or more of the items mentioned before and after “and/or”. For instance, a phrase “item 1 and/or item 2” and similar phrases may relate to one or m“re of item” 1 and item 2. The term “compris“ng” may in an” embodiment refer to “consisting of” but may i “another embodiment also refer to “containing at least the defined species and o”tionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices, apparatus, or systems may herein amongst others be described during operation. As will be clear to the person skilled in the art, the invention is not limited to methods of operation, or devices, apparatus, or systems in operation.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as lim“ting the cl”im.

Use of the verb “to comprise” and its conjugations does not exclude the presence of elements or steps other than those stated in a claim. Unless the context clearly requires otherwise, throughout the description and the claims, the words “comprise”, “comprising”, and the like are to be construed in an inclusive sense as opposed to an exclusive or exhaustive sense; that is to say, in the sense of “including, “u” not “li”ited to”.

The article “a” or “an” preceding an element does not exclude the presence of a plurality of such elements.

The invention may be implemented by means of hardware comprising several distinct elements, and by means of a suitably programmed computer. In a device claim, or an apparatus claim, or a system claim, enumerating several means, several of these means may be embodied by one and the same item of hardware. The mere fact that certain measures are recited in mutually different dependent claims does not indicate that a combination of these measures cannot be used to advantage.

The invention also provides a control system that may control the device, apparatus, or system, or that may execute the herein described method or process. Yet further, the invention also provides a computer program product, when running on a computer which is functionally coupled to or comprised by the device, apparatus, or system, controls one or more controllable elements of such device, apparatus, or system.

The invention further applies to a device, apparatus, or system comprising one or more of the characterizing features described in the description and/or shown in the attached drawings. The invention further pertains to a method or process comprising one or more of the characterizing features described in the description and/or shown in the attached drawings.

The various aspects discussed in this patent can be combined in order to provide additional advantages. Further, the person skilled in the art will understand that embodiments can be combined, and that also more than two embodiments can be combined. Furthermore, some of the features can form the basis for one or more divisional applications.

It goes without saying that one or more of the first (printable or printed) material and second (printable or printed) material may contain fillers such as glass and fibers which do not have (to have) influence on the on T_{g} or Tₘ of the material(s).

1. A method for producing a 3D printed item by means of fused deposition modelling, wherein the 3D printed item comprises a plurality of layers of 3D printed material, comprising a layer part with a 3D printed shell material at least partially surrounding a 3D printed core material, wherein the method comprises layer-wise depositing a 3D printable material comprising a 3D printable core material and a 3D printable shell material,
wherein:
the 3D printable core material comprises one or more of metal particles and a metal wire, and the 3D printable shell material comprises wood particle, or
the 3D printable core material comprises wood particles, and the 3D printable shell material comprises inorganic material particles selected from the group of glass particles and ceramic particles, and
wherein:
the 3D printable core material comprises a volume percentage V_{c,W} wood particles, a volume percentage V_{c,M} metal material, and a volume percentage V_{c,I} inorganic material particles,
the 3D printable shell material comprises a volume percentage V_{s,W} wood particles, a volume percentage V_{s,M} metal material, and a volume percentage V_{s,I} inorganic material particles, and
V_{s,M}/V_{c,M}≤0.1, V_{c,I}/V_{s,I}≤0.1, 0 vol. %≤V_{c,M}≤100 vol. %, and 0 vol. %≤V_{s,I}≤50 vol. %.

2. The method according to claim 1, wherein the 3D printable core material comprises one or more of (i) a metal wire (270), and (ii) a thermoplastic material with metal particles embedded therein.

3. The method according to claim 2, wherein the method comprises selecting the 3D printable core material and the 3D printable shell material and controlling relative volumes of the 3D printable core material and the 3D printable shell material such that the 3D printed material has a specific weight of at least 5 g/cm³.

4. The method according to claim 2, wherein the method comprises selecting the 3D printable shell material and choosing 3D printing conditions such that the 3D printed shell material is not transparent for visible light.

5. The method according to claim 1, wherein the 3D printable core material comprises wood particles, wherein the 3D printable shell material comprises inorganic material particles; and wherein the method comprises selecting the 3D printable shell material and choosing 3D printing conditions such that the 3D printed shell material is transmissive for visible light.

6. The method according to claim 1, wherein at least part of the inorganic material particles protrudes from the 3D printed shell material.

7. The method according to claim 1, wherein the 3D printable shell material comprises at least 20 vol. % of the inorganic material particle, and wherein at least part of the inorganic material particles have a dimension selected from 80-120% of a thickness of the 3D printed shell material.

8. The method according to claim 1, wherein:
when V_{s,W}>V_{c,W} then (i) 0 vol. %<V_{c,M}≤100 vol. % and (ii) and V_{s,I}≤V_{s,M}; and
when V_{c,W}>V_{s,W} then (i) 0 vol. %<V_{s,I}≤50 vol. % and (ii) and V_{c,M}≤V_{c,I}.

9. A 3D printed item comprising 3D printed material, wherein the 3D printed item comprises a plurality of layers of 3D printed material, wherein a layer part comprises 3D printed core material and 3D printed shell material at least partially surrounding the 3D printed core material,
wherein:
the 3D printed core material comprises one or more of metal particles and the metal wire, and the 3D printed shell material comprises wood particles, or
the 3D printed core material comprises wood particles, and the 3D printed shell material comprises inorganic material particles selected from the group of glass particles and ceramic particles, and
wherein:
the 3D printed core material comprises a volume percentage V_{c,W} wood particles, a volume percentage V_{c,M} metal material, and a volume percentage V_{c,I} inorganic material particles,
the 3D printed shell material comprises a volume percentage V_{s,W} wood particles, a volume percentage V_{s,M} metal material, and a volume percentage V_{s,I} inorganic material particles, and
V_{s,M}/V_{c,M}≤0.1, V_{c,I}/V_{s,I}≤0.1, 0 vol. %≤V_{c,M}≤100 vol. %, and 0 vol. %≤V_{s,I}≤50 vol. %.

10. The 3D printed item according to claim 9, wherein the 3D printed core material comprises one or more of a metal wire, and a thermoplastic material with metal particles embedded therein; wherein the layer part has a specific weight of at least 5 g/cm³.

11. The 3D printed item according to claim 9, wherein the 3D printed shell material is not transparent for visible light.

12. The 3D printed item according to claim 9, wherein the 3D printed core material comprises wood particles, and wherein the 3D printed shell material comprises inorganic material particles; and wherein the 3D printed shell material is transmissive for visible light; wherein at least part of the inorganic material particles protrude from the 3D printed shell material; wherein the 3D printed shell material comprises at least 10 vol. % of the inorganic material particles.

13. The 3D printed item according to claim 9, wherein:
when V_{s,W}>V_{c,W} then (i) 0 vol. %<V_{c,M}≤100 vol. % and (ii) and V_{s,I}≤V_{s,M}; and
when V_{c,W}>V_{s,W} then (i) 0 vol. %<V_{s,M}≤50 vol. % and (ii) and V_{c,M}≤V_{c,I}.

14. A lighting device comprising a 3D printed item, wherein the 3D printed item comprises 3D printed material, wherein the 3D printed item comprises a plurality of layers of 3D printed material, wherein a layer part comprises 3D printed core material and 3D printed shell material at least partially surrounding the 3D printed core material, wherein:
the 3D printed core material comprises one or more of metal particles and a metal wire, and the 3D printed shell material comprises wood particles, or
the 3D printed core material comprises wood particles, and the 3D printed-shell material comprises inorganic material particles selected from the group of glass particles and ceramic particles, and
wherein the 3D printed item is configured as one or more of at least part of a lighting device housing, at least part of a wall of a lighting chamber, and an optical element.
